(19) United States
(12) Patent Application Publication
(10) Pub. No.: US 2026/0142997 A1
(43) Pub. Date: May 21, 2026

(54) Artificial Intelligence (AI)-Based Smart Actioning System

(71) Applicant: eBay Inc., San Jose, CA (US)

(72) Inventor: Rahul Ranjan Sharma, Mountain View, CA (US)

(73) Assignee: eBay Inc., San Jose, CA (US)

(21) Appl. No.: 18/955,125

(22) Filed: Nov. 21, 2024

(51) Int. Cl. H04L 9/40; G06F 16/9538; G06N 5/01

(52) U.S. Cl. CPC H04L 63/1433; G06F 16/9538; G06N 5/01

(57) ABSTRACT

An artificial intelligence (AI)-based smart actioning system is described. A system receives an activity associated with a website, the activity having one or more attributes. Based on the attributes, the system generates a vector associated with the activity. The system executes a machine learning model that is training using a dataset including a vector space of a set of vectors associated with a set of historical activities associated with the website. This may include executing a vector space similarity search, such as a k-nearest neighbor (k-NN) search, between the vector and the set of vectors. The system generates a prompt for a large language model (LLM) based on one or more vectors identified from the vector space similarity search, and outputs a result received from the LLM that indicates a risk level of the activity.

### BACKGROUND

Online marketplaces support and thus experience numerous and varied activities that facilitate transactions on the online marketplace. Some such activities may be automatically identified as safe or as fraudulent based on a set of deterministic rules, where safe activities may be approved and fraudulent activities may be rejected. If an activity does not satisfy a deterministic rule, a customer support agent may be tasked with reviewing the activity to determine whether it is safe to allow or fraudulent and should thus be rejected.

### SUMMARY

Artificial intelligence (AI)-based smart actioning is leveraged with an online marketplace. In one or more implementations, an activity associated with a website is received, and the activity is associated with one or more attributes that describe the activity. Based on the attributes, a vector associated with the activity is generated. The vector is provided as input to a machine learning model that is trained using a dataset of historical activities associated with the website. Executing the machine learning model may include executing a vector space similarity search between the vector and a set of vectors representative of the historical activities used to train the machine learning model. Based on one or more vectors of the set of vectors identified from the vector space similarity search, a prompt for a large language model (LLM) may be generated. An output received from the LLM that indicated a risk level of the activity may be output (e.g., to a user interface).

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of an environment in an example implementation that is operable to employ techniques described herein.

FIG. 2 depicts an example of a system to indicate a risk level of an activity for an AI-based smart actioning system.

FIG. 3 depicts an example of a system to build a historical activity base for an AI-based smart actioning system.

FIG. 4 depicts an example of a system to generate a query embedding for an AI-based smart actioning system.

FIG. 5 depicts an example of a system to perform a similarity search for an AI-based smart actioning system.

FIG. 6 depicts an example of a system to generate an AI decision for an AI-based smart actioning system.

FIG. 7 depicts an example of a user interface for an AI-based smart actioning system.

FIG. 8 depicts a procedure in an example implementation of an AI-based smart actioning system.

FIG. 9 illustrates an example of a system that includes an example computing device that is representative of one or more computing systems and/or devices that may implement the various techniques described herein.

### DETAILED DESCRIPTION

### Overview

An AI-based smart actioning system is described. In accordance with the described techniques, items may be available (e.g., listed) for sale on an online marketplace. In one or more implementations, the online marketplace may be accessible by decentralized computing devices that correspond to “clients” of the online marketplace, e.g., users that have accounts with the online marketplace. In at least some scenarios, each user may have a corresponding user profile that includes information such as the user’s home address, a user’s internal profile rating, and the like. Users of the online marketplace may have some control over which items they list with or purchase from the online marketplace. For example, the users may determine when to list or purchase items and may do so from different locations via a website or mobile application for the online marketplace.

Customer support (e.g., service) agents for the online marketplace may utilize a risk action service (e.g., platform) to perform payment and risk assessments. For example, the risk action service may identify activities that occur on the online marketplace, such as a user attempting to make a purchase, signing in to their account, or listing an item for sale, among other activities. Upon receiving a request associated with a new activity, the risk action service may employ a set of deterministic rules to determine whether each activity is safe (e.g., low-risk, legitimate) or fraudulent (e.g., high-risk, illegitimate).

Based on the rules, some activities may be automatically determined to be safe and approved, while other activities may be automatically determined to be fraudulent and rejected. For example, the risk action service may detect that a new user is attempting to make a high-value purchase, such as a smartphone (e.g., the activity). The risk action service may determine that this activity is safe based on the user’s profile and allow the transaction to occur. In another example, the risk action service may detect that a seller with a home address in the United States is attempting to make a sale while logged in from a country in which the online marketplace is not accessible (e.g., through a virtual private network (VPN)). Based on the location of the activity, the risk action service may automatically block the transaction, deeming the transaction fraudulent. In another example, the risk action service may automatically block transactions involving items known to be illegal or pirated.

In one or more implementations, the risk action service may determine whether an activity is fraudulent based on a user’s internal profile rating. For example, if a user has an internal profile rating of four or five stars out of five, the risk action service may determine that the activity is safe and allow the activity to occur. If the internal profile rating is below three stars out of five, the risk action service may determine that the activity is fraudulent, and may at least perform additional validations before allowing or blocking the transaction.

However, each activity may have many complexities and as such may not satisfy the deterministic rules clearly. For example, if a user’s internal profile rating is three out of five stars, or if the activity is otherwise not sufficiently safe or fraudulent according to a deterministic rule, the risk action service may send the activity for manual review by a human customer support agent. That is, these activities may be determined as low or high risk but with a very low confidence (e.g., low confidence decision outcomes). In such cases, a customer support agent may use any available data about the transaction to determine whether the activity is legitimate or not. The customer support agent may use the user’s profile to determine how many items they have purchased and listed in the past, how many times they have logged in to their account, and the amount of time they typically spend on the online marketplace when logged in, among other attributes. Then, the customer support agent may decide to either allow or block the transaction.

Relying on customer support agents to manually review activities may provide a host of challenges. Where the online marketplace supports a great many users (e.g., tens, hundreds, thousands, millions, etc.), for instance, it is impossible for a team of customer support agents to review every activity that does not satisfy a deterministic rule. This is particularly true as the number of new users joining the online marketplace and the volume of transactions on the online marketplace continue to increase. As the online marketplace’s customer base grows further, the cost of performing manual review and actioning on user accounts would rise significantly. Additionally, if there are not enough customer support agents to handle all of the activities, unreviewed activities may “time-out” and be treated with some default deterministic rules, which may allow fraudulent activities to occur or may prevent safe activities from occurring. As such, fraudulent transactions may become more common, resulting in fewer transactions.

Thus, to solve the problems associated with the cost of manual review and actioning of user accounts and activities, the described smart actioning techniques use AI to automate manual actioning on user accounts for low-confidence decision outcomes. In accordance with the described techniques, historical manual actioning results from customer support agents may be used to identify and automate actioning on similar, new activities using vector embeddings, vector space similarity searches, and LLMs. The AI-based smart actioning system may receive an activity associated with the online marketplace (e.g., that occurred on a website or mobile application for the online marketplace), where the activity may have one or more attributes that describe the activity. For example, the attributes may include the time of the activity, the location of the activity, a value of a transaction, and the like. The system may generate a vector associated with the activity based on the attributes and using one or more vectorization techniques.

The system may generate a machine learning model that is trained using a dataset including a vector space. The vector space may include a set of vectors that is associated with a set of historical activities associated with the online marketplace, such that the vectors in the set of vectors describe the historical activity, e.g., a vector per historical activity vectorized. That is, the set of vectors may represent historical actioning results previously gathered and responded to manually by customer support agents. In one or more implementations, executing the machine learning model may include executing a vector space similarity search between the generated vector and the set of vectors in the vector space. Based on one or more vectors of the set of vectors identified from the vector space similarity search, the system may generate a prompt for an LLM, which the LLM may use to make a determination regarding the risk level of the activity. The system may receive an output (e.g., result) from the LLM that indicates the risk level of the activity and output the result for display (e.g., via a user interface). For example, the output may indicate that an activity is low-risk and approved, or the output may indicate that the activity is a high-enough risk that the activity should be restricted or blocked.

In at least one variation, the set of historical activities may be manually labeled with risk levels based on a set of deterministic rules. That is, the machine learning model may be trained to identify activities that may be automatically allowed or automatically restricted. Additionally, the set of historical activities may be updated as the system determines a risk level for each new activity so that the system may recognize more similar activities in the future. In some examples, utilizing the machine learning model in this way may result in improved utilization of customer support agents as they may use their time to determine risk levels of more complex activities. For example, customer support agents may manually review activities that have not been seen before, but otherwise allow the machine learning model to determine the risk levels for more common or frequent activities. As such, the described techniques may improve resource utilization and efficiency as the system is continuously updated with new activities and can therefore recognize more received activities over time.

Additionally, the described techniques may reduce the computational resources and time required for automating review and actioning for activities and user accounts. That is, instead of applying a set of deterministic rules to each new activity, which may apply to only common activities, the system may more efficiently determine the risk level for new activities that has some level of similarity to previous activities using vector space similarity searching and LLMs. Additionally, continuously updating the training dataset for the machine learning model when risk levels are determined for new activities may improve accuracy of the vector space similarity search and subsequent risk level determinations. This may also result in improved security of the online marketplace as more fraudulent activities are restricted or blocked.

In some aspects, the techniques described herein relate to a computer-implemented method including: receiving an activity associated with a website, the activity having one or more attributes; generating a vector associated with the activity based on the one or more attributes; executing a machine learning model that is trained using a dataset including a vector space comprising a set of vectors representing a set of historical activities associated with the website, the executing including executing a vector space similarity search between the vector and the set of vectors; generating a prompt for an LLM based on one or more vectors of the set of vectors identified from the vector space similarity search; and outputting a result received from the LLM that indicates a risk level of the activity.

In some aspects, the techniques described herein relate to a computer-implemented method further including providing the prompt as input to the LLM to determine the risk level of the activity; and outputting the result received from the LLM for display via a user interface.

In some aspects, the techniques described herein relate to a computer-implemented method, wherein the prompt includes a request associated with the activity, the one or more vectors identified from the vector space similarity search, and an input request to output the risk level.

In some aspects, the techniques described herein relate to a computer-implemented method further including adding the vector associated with the activity to the vector space based at least in part on the result.

In some aspects, the techniques described herein relate to a computer-implemented method, wherein the set of vectors included in the dataset are associated with risk levels based on at least one of: a set of deterministic rules, manual review by a user, or an output from the LLM.

In some aspects, the techniques described herein relate to a computer-implemented method, further including sending the activity and the one or more attributes for evaluation by a user based at least in part on a quantity of the one or more vectors identified from the vector space similarity search failing to satisfy a threshold.

In some aspects, the techniques described herein relate to a computer-implemented method, further including validating the result received from the LLM based at least in part on an evaluation of the vector associated with the activity performed by a user.

In some aspects, the techniques described herein relate to a computer-implemented method, wherein the vector space similarity search comprises a k-nearest-neighbor (k-NN) search, and wherein the k-NN search is based on a minimum confidence score.

In some aspects, the techniques described herein relate to a computer-implemented method, wherein the result received from the LLM indicates an action associated with the activity based at least in part on the risk level.

In some aspects, the techniques described herein relate to a system including: a machine learning model that is trained using a dataset including a vector space, the vector space comprising a set of vectors representing a set of historical activities associated with a website; an LLM; and a risk action service configured to: receive an activity associated with the website, the activity having one or more attributes; generate a vector associated with the activity based on the one or more attributes; execute the machine learning model, the executing including executing a vector space similarity search between the vector and the set of vectors; generate a prompt for the LLM based on one or more vectors of the set of vectors identified from the vector space similarity search; and output a result received from the LLM that indicates a risk level of the activity.

In some aspects, the techniques described herein relate to a system, wherein the risk action service is configured to provide the prompt as input to the LLM to determine the risk level of the activity; and output the result received from the LLM for display via a user interface.

In some aspects, the techniques described herein relate to a system, wherein the prompt includes a request associated with the activity, the one or more vectors identified from the vector space similarity search, and an input request to output the risk level.

In some aspects, the techniques described herein relate to a system, wherein the risk action service is configured to add the vector associated with the activity to the vector space based at least in part on the result.

In some aspects, the techniques described herein relate to a system, wherein the set of vectors included in the dataset are associated with risk levels based on at least one of: a set of deterministic rules, manual review by a user, or an output from the LLM.

In some aspects, the techniques described herein relate to a system, wherein the risk action service is configured to send the activity and the one or more attributes for evaluation by a user based at least in part on a quantity of the one or more vectors identified from the vector space similarity search failing to satisfy a threshold.

In some aspects, the techniques described herein relate to a system, wherein the risk action service is configured to validate the result received from the LLM based at least in part on an evaluation of the vector associated with the activity performed by a user.

In some aspects, the techniques described herein relate to a system, wherein the vector space similarity search comprises a k-NN search, and wherein the k-NN search is based on a minimum confidence score.

In some aspects, the techniques described herein relate to a system, wherein the result received from the LLM indicates an action associated with the activity based at least in part on the risk level.

In some aspects, the techniques described herein relate to one or more computer-readable storage media including computer-executable instructions stored thereon that, responsive to execution by one or more processors, perform operations including: receiving an activity associated with a website, the activity having one or more attributes; generating a vector associated with the activity based on the one or more attributes; executing a machine learning model that is trained using a dataset including a vector space comprising a set of vectors representing a set of historical activities associated with the website, the executing including executing a vector space similarity search between the vector and the set of vectors; generating a prompt for an LLM based on one or more vectors of the set of vectors identified from the vector space similarity search; and outputting a result received from the LLM that indicates a risk level of the activity.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

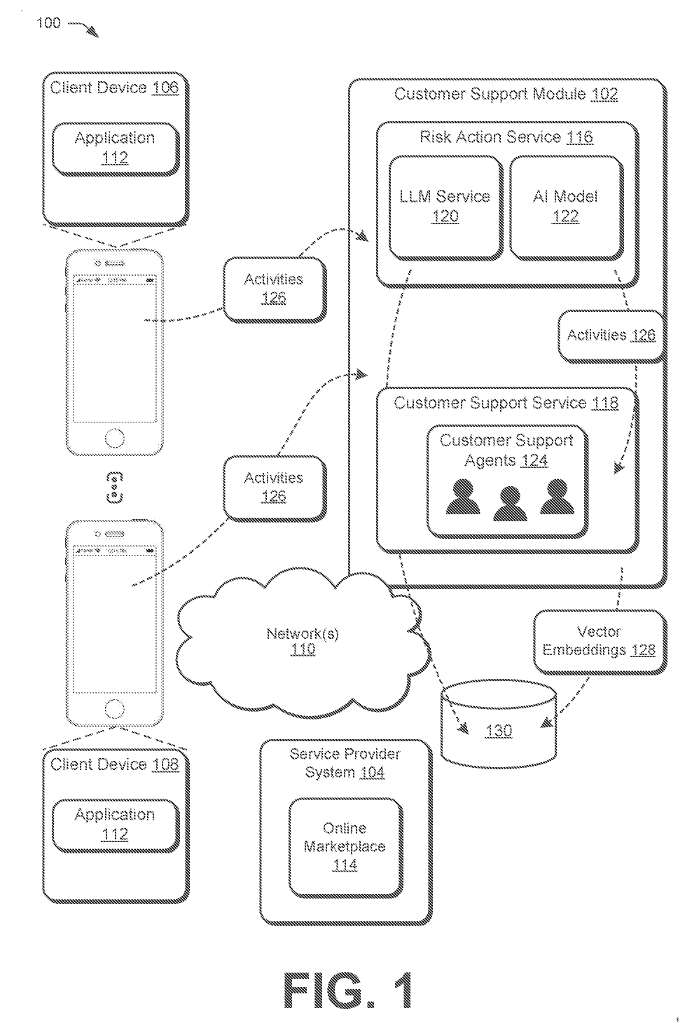

FIG. 1 is an illustration of an environment 100 in an example implementation that is operable to employ techniques described herein. The environment 100 includes a customer support module 102, a service provider system 104, and numerous client devices (represented in the environment 100 by client device 106 and client device 108). In one or more implementations, the customer support module 102, the service provider system 104, and the client devices 106 and 108 are communicatively coupled, one to another, via network(s) 110. One example of the network(s) 110 is the Internet, although one or more of the customer support module 102, the service provider system 104, and the client devices 106 and 108 may be communicatively coupled using one or more different connections or different networks in various implementations (e.g., a cloud).

Although the customer support module 102 is depicted in the environment 100 as being separate from the service provider system 104, in one or more implementations, an entirety or various portions of the customer support module 102 are implemented at or by the service provider system 104. In at least one implementation, for example, at least a portion of the customer support module 102 is implemented by resources (e.g., server-based storage, processing, and so on) of the service provider system 104. Alternatively, or additionally, at least a portion of the customer support module 102 is implemented using a third-party service, such as a web services platform that provides one or more hardware and/or other computing resources to support provision of services by web service providers.

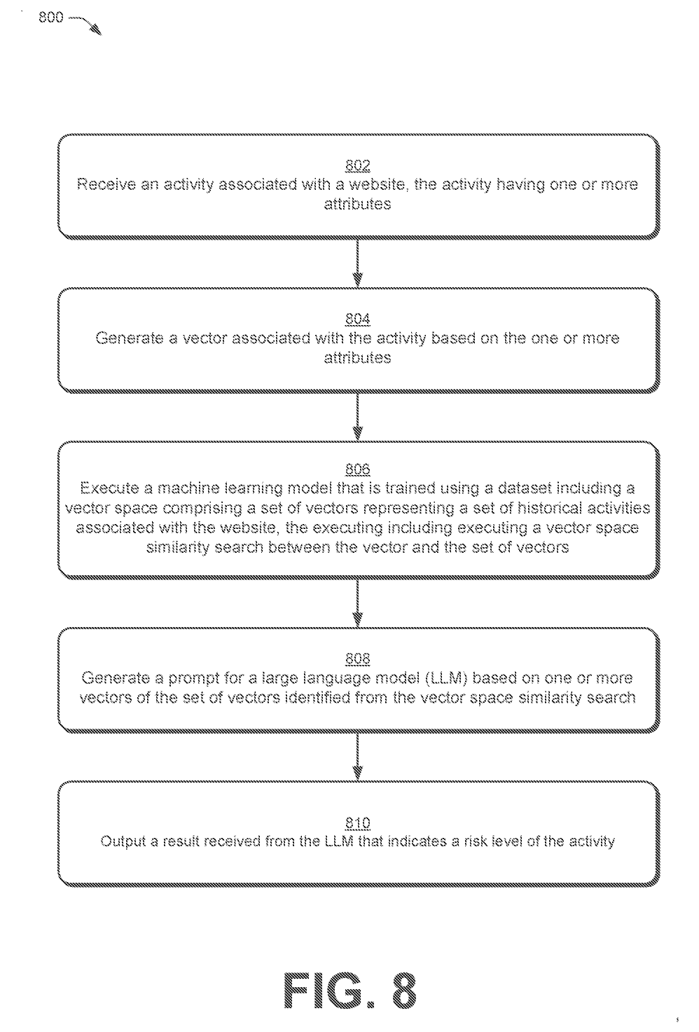

Computing devices that implement the environment 100 are configurable in a variety of ways. A computing device, for instance, is configurable as a desktop computer, a laptop computer, a mobile device (e.g., assuming a handheld configuration such as a tablet or mobile phone), an Internet-of-Things (IoT) device, a wearable device (e.g., a smart watch, a ring, or smart glasses), an augmented reality (AR)/virtual reality (VR) device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 8.

In at least one implementation, the application 112 supports communication of data across the network(s) 110 between the client devices 106 and 108 and the service provider system 104. By supporting such data communication, the application 112 provides a respective user of the client devices 106 and 108 (and users of other client or computing devices) access to an online marketplace 114. For example, the client devices 106 and 108 receive data from the service provider system 104. Based on the received data, the application 112 causes various systems of the client devices 106 and 108 to output user interfaces of the online marketplace 114, such as by displaying user interfaces via display devices or making accessible voice-based user interfaces.

Through interaction of a user with the client devices 106 and 108, the application 112 receives user input via one or more user interfaces of the online marketplace 114. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 112 is a browser, which is operable to navigate to a website of the online marketplace 114, display pages of the website, and facilitate user interaction with web pages of the online marketplace 114’s website. Another example of the application 112 is a web-based computer application of the online marketplace 114, such as a mobile application or a desktop application. The application 112 may be configured in different ways, which enable users to interact with their computing devices and by extension perform actions on the online marketplace 114, without departing from the spirit or scope of the techniques described herein.

In one or more implementations, users register with the service provider system 104 to obtain respective user accounts with the online marketplace 114. Such registration may include, for instance, providing an email address and establishing a username and password combination. Subsequent to registering with the service provider system 104, computing devices (e.g., the client devices 106 and 108) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 114 may be a guest account that does not require a user to sign in or otherwise authenticate to an already established account before interacting with the online marketplace 114.

Broadly speaking, the online marketplace 114 is configured to generate listings for items and to expose those listings (e.g., publish them) to one or more computing devices, including the client devices 106 and 108. For example, the online marketplace 114 may generate listings for items for sale and expose those listings to computing devices, such that the users of the computing devices can interact with the listings via user interfaces to initiate transactions (e.g., purchases, sales, add to wish lists, share, and so on) in relation to the respective item or items of the listings. In accordance with the described techniques, the online marketplace 114 is configured to generate listings for one or more types of physical goods or property (e.g., clothing and/or clothing accessories, collectibles, furniture, decorative items, textiles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 110, and blockchain backed assets (e.g., non-fungible tokens (NFTs)), to name just a few. In one or more implementations, the online marketplace 114 is accessible (e.g., via the client devices 106 and 108) by decentralized computing devices that correspond to “clients” of the online marketplace 114, e.g., users that have accounts with the online marketplace 114.

In the illustrated environment 100, the customer support module 102 includes a risk action service 116 and a customer support service 118. The customer support module 102 may be used to perform payment and risk assessments of activities 126 that occur on the online marketplace 114. The risk action service 116 may support an LLM service 120 and an AI model 122 (e.g., a machine learning model), or some other AI platforms. The customer support service 118 may provide a platform for customer support agents 124, who are employees of the online marketplace.

The risk action service 116 may identify activities 126 that occur on the online marketplace, such as a user attempting to make a purchase, signing in to their account, or listing an item for sale, among other activities via the application 112. The client devices 106 and 108 may communicate the activities 126 to the customer support module 102 via the network(s) 110. Upon receiving a request associated with an activity 126, the risk action service 116 may employ a set of deterministic rules to determine whether each activity 126 is safe or fraudulent. Based on the rules, some activities 126 may be automatically determined to be safe and approved, while other activities may be automatically determined to be fraudulent and rejected. For example, the risk action service 116 may detect that a new user is attempting to make a high-value purchase, such as a smartphone (e.g., the activity 126). The risk action service 116 may determine that this activity 126 is safe based on the user’s profile and allow the transaction to occur. In another example, the risk action service 116 may detect that a seller with a home address in the United States is attempting to make a sale while logged in via a client device 106 or a client device 108 from a country in which the online marketplace is not accessible (e.g., through a VPN). Based on the location of the client, the risk action service 116 may automatically block the transaction, deeming the transaction fraudulent. In another example, the risk action service 116 may automatically block transactions involving items known to be illegal or pirated.

In one or more implementations, the risk action service 116 may determine whether an activity 126 is fraudulent based on a user’s internal profile rating. For example, if a user has an internal profile rating of four or five stars out of five, the risk action service 116 may determine that the activity 126 is safe and approve it. If the internal profile rating is below three stars out of five, the risk action service 116 may determine that the activity 126 is fraudulent, and may at least perform additional validations before likely rejecting or blocking the activity 126.

However, each activity 126 may have many complexities and as such may not satisfy the deterministic rules clearly. For example, if a user’s internal profile rating is three out of five stars, or if the activity 126 is otherwise not sufficiently safe or fraudulent according to a deterministic rule, the risk action service 116 may send the activity for manual review by the customer support agents 124. That is, these activities 126 may be determined as low or high risk but with a very low confidence (e.g., low confidence decision outcomes). The customer support agents 124 may use any available data about the transaction to determine whether the activity 126 is legitimate or not. The customer support agents 124 may use the user’s profile to determine how many items they have purchased and listed in the past, how many times they have logged in to their account, and the amount of time they typically spend on the online marketplace when logged in, among other attributes. Then, the customer support agents 124 may decide to either allow or block the transaction.

Relying on customer support agents 124 to manually review activities may provide a host of challenges. Where the online marketplace 114 supports a great many users (e.g., tens, hundreds, thousands, millions, etc.), for instance, it is impossible for a team of customer support agents 124 to review every activity that does not satisfy a deterministic rule. This is particularly true as the number of new users joining the online marketplace 114 and the volume of transactions on the online marketplace 114 continue to increase. As the online marketplace 114’s customer base grows further, the cost of performing manual review and actioning on user accounts would rise significantly. Additionally, if there are not enough customer support agents 124 to handle all of the activities, unreviewed activities may “time-out” and be treated with some default deterministic rules, which may allow fraudulent activities to occur or may prevent safe activities from occurring. As such, fraudulent transactions may become more common, resulting in fewer transactions.

Thus, to solve the problems associated with the cost of manual review and actioning of user accounts and activities, the described smart actioning techniques use AI to automate manual actioning on user accounts for low-confidence decision outcomes. In accordance with the described techniques, historical manual actioning results from customer support agents 124 may be used to identify and automate actioning on similar, new activities 126 using vector embeddings 128, vector space similarity searches, and LLMs. The customer support module 102 may receive an activity 126 associated with the online marketplace 114 (e.g., that occurred on an application 112 for the online marketplace 114 via a client device 106 or a client device 108). The customer support module 102 may receive activities 126 via communications over the network(s) 110. Each activity 126 may have one or more attributes. For example, the attributes may include the time of the activity 126, the location of the activity 126, a value of a transaction, and the like. The risk action service 116 may generate vector embeddings 128 associated with the activities 126 based on their respective attributes.

The AI model 122 may be trained using a dataset including a vector space. The vector space may include a set of vectors associated with a set of historical activities associated with the online marketplace 114, and may be stored at a database 130. The database 130 may be a storage device that represents one or more databases and/or other types of storage capable of storing the vector embeddings 128 and/or other data used by the customer support module 102 to perform actioning for the online marketplace 114. Examples of the database 130 include, but are not limited to, mass storage and virtual storage. In one or more implementations, for example, the database 130 may be virtualized across a plurality of data centers and/or cloud-based storage devices.

The set of vectors may represent historical actioning results previously gathered manually by customer support agents 124. In one or more implementations, executing the AI model 122 may include executing a vector space similarity search between the generated vector and the set of vectors in the vector space (stored at the database 130). Based on one or more vectors of the set of vectors identified from the vector space similarity search, the risk action service 116 may use the LLM service 120 to generate a prompt for an LLM, which the LLM may use to make a determination regarding the risk level of the activities 126. The risk action service 116 may receive an output (e.g., result) from the LLM that indicates the risk level of the activity and output the result for display (e.g., via a user interface). For example, the output may indicate that an activity 126 is low-risk and thus should be approved, or the output may indicate that the activity 126 is a high-enough risk that the activity 126 should be restricted or blocked.

Having considered an example of an environment, consider now a discussion of some example details of the techniques for AI-based smart actioning in accordance with one or more implementations.

### AI-Based Smart Actioning System

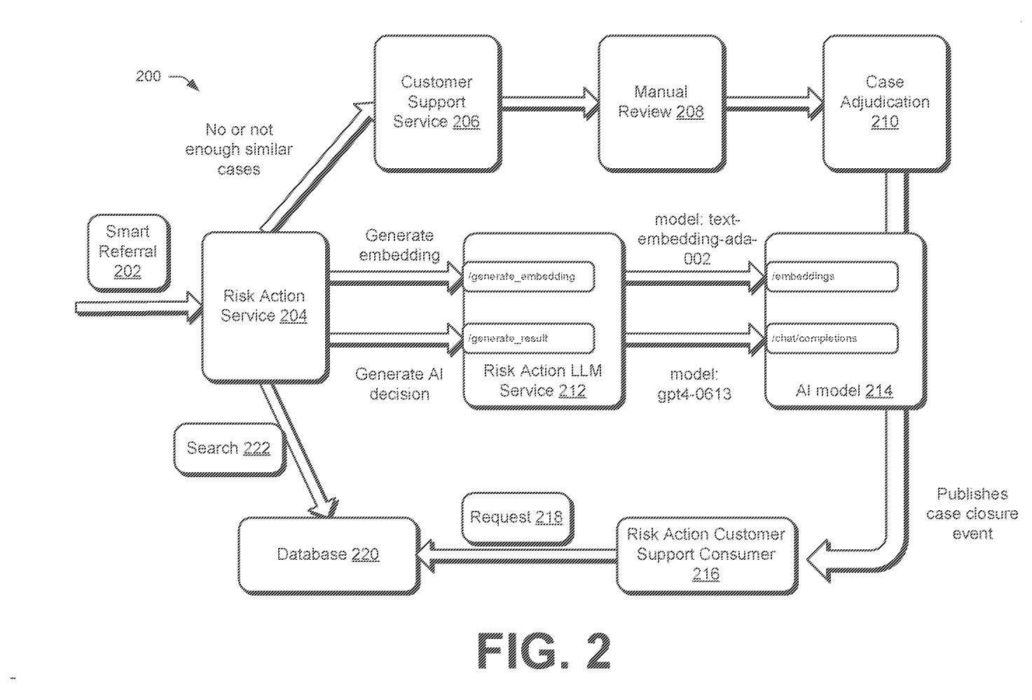

FIG. 2 depicts an example 200 of a system for indicating a risk level of an activity for an AI-based smart actioning system. The example 200 may be implemented in or otherwise supported by the customer support module 102, the service provider system 104, and the client devices 106 and 108, as described with reference to FIG. 1. For instance, the example 200 may include a risk action service 204 (which may be an example of the risk action service 116), a customer support service 206 (which may be an example of a customer support service 118), a risk action LLM service 212 (which may be an example of an LLM service 120), and an AI model 214, which may be an example of an AI model 122).

In the example 200, the risk action service 204 may support customer support agents for an online marketplace. The risk action service 204 may operate to identify activities that occur on at the online marketplace, such as a user attempting to make a purchase, signing in to their account, listing an item for sale, and the like. For example, the risk action service 204 may receive a new activity (e.g., website activity) via a smart referral 202. The activity may have a set of attributes, such as a user identifier, a date and time, and any other attributes that define the nature of the activity.

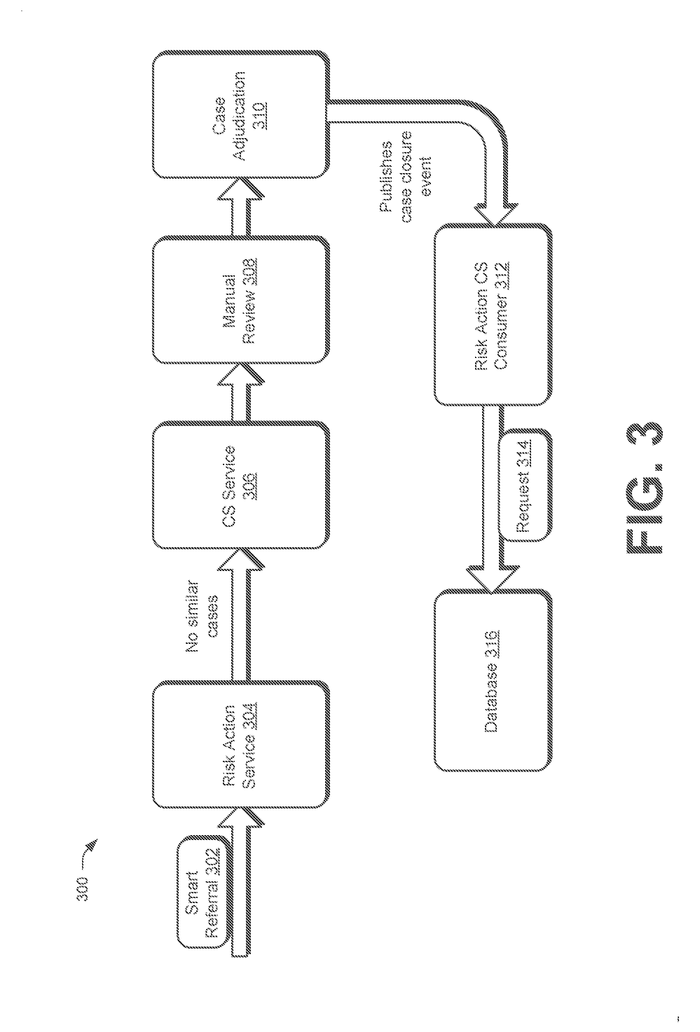

If this activity is the first of its kind to be referred to the risk action service 204, the risk action service 204 may send the activity to the customer support service 206. That is, as described with reference to FIG. 3, the activity may be sent to the customer support service 206 if there are no similar or not enough similar activities (e.g., cases) stored in the database 220. The customer support service 206 may be an electronic platform used by human customer support agents to perform manual review 208 and actioning for the online marketplace. A customer support agent may perform the manual review 208 of the activity by reviewing the attributes. The customer support agent may then perform a case adjudication 210 and provide a final determination or outcome, based on the attributes, as to a risk level of the activity and a corresponding final action. For example, if the activity is a transaction, the customer support agent may determine, and indicate via user input, that the risk level is low (e.g., satisfies or is below a threshold) and approve the transaction or that the risk level is high (e.g., fails to satisfy or exceeds a threshold) and reject the transaction. In some implementations, the customer support agent may indicate a reasoning for the risk level and subsequent action. For example, the risk level may be determined based on one or more particular attributes of the activity.

After the case adjudication 210, the system may generate and publish an event (e.g., a case closure event) that indicates a request associated with the activity, the attributes of the activity, and the outcome of the case adjudication 210. The event may be published at a risk action customer support consumer 216, which may generate a vector (e.g., a vector embedding) that represents the activity. The risk action customer support consumer 216 may transmit a request 218 to the database 220, where the request 218 may include the vector embedding (e.g., the vector representation of the activity) and the outcome. The request 218 may be stored at the database 220 such that risk action service 204 may utilize the request for a future vector space similarity search. The database 220 may support searching, data visualization, and data analytics.

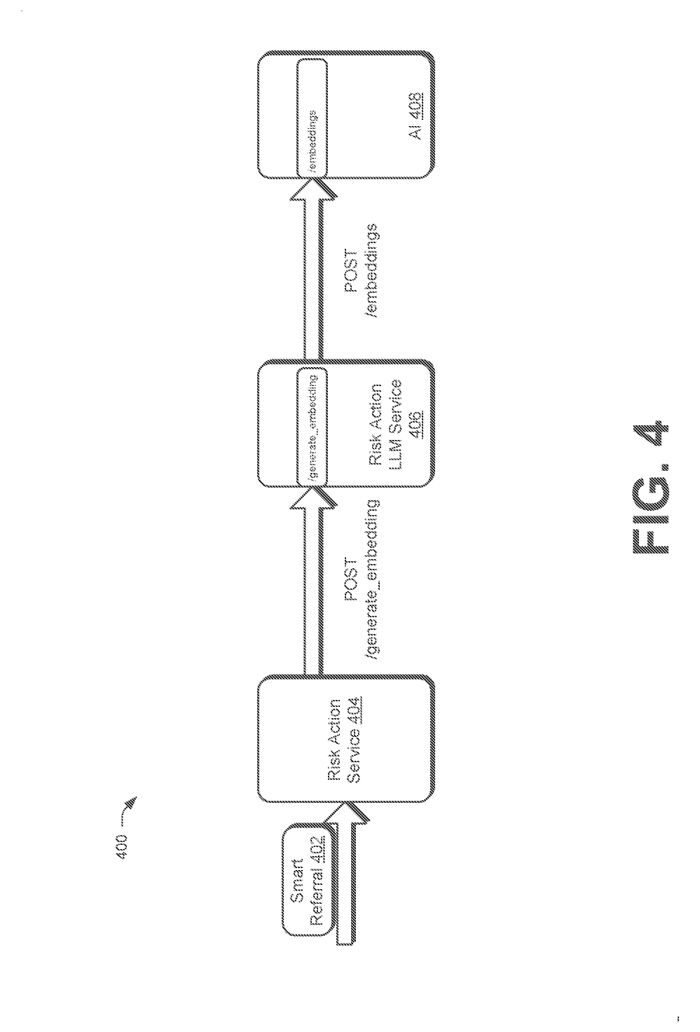

In one or more implementations, the risk action service 204 may send the activity to a risk action LLM service 212 or an AI model 214 to generate a vector embedding based on the attributes of the activity. As described with reference to FIG. 4, the risk action LLM service 212 or the AI model 214 may convert the attributes of the activity to an embedded vector. For example, depending on a desired vector complexity, the risk action LLM service 212 may generate the vector embedding (e.g., /generate_embedding using an ADA_002 algorithm) or the AI model 214 may generate the vector embedding (e.g., /embeddings using a text-embedding-ada-002 model).

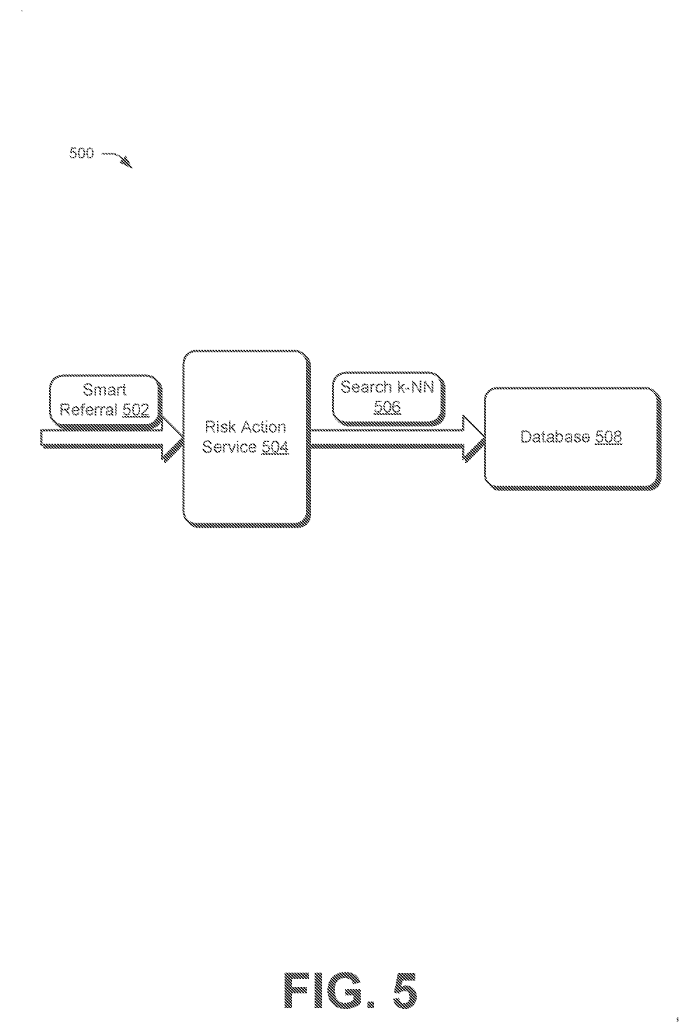

With the activity represented as a vector, the risk action service 204 may use the vector embeddings and outcomes already stored at the database 220 to perform a vector space similarity search 222. For example, the system may execute a k-nearest neighbor (k-NN) search between the vector generated for the activity and a vector space that includes the vector embeddings and outcomes stored at the database 220. The vector space similarity search 222 is described with reference to FIG. 5.

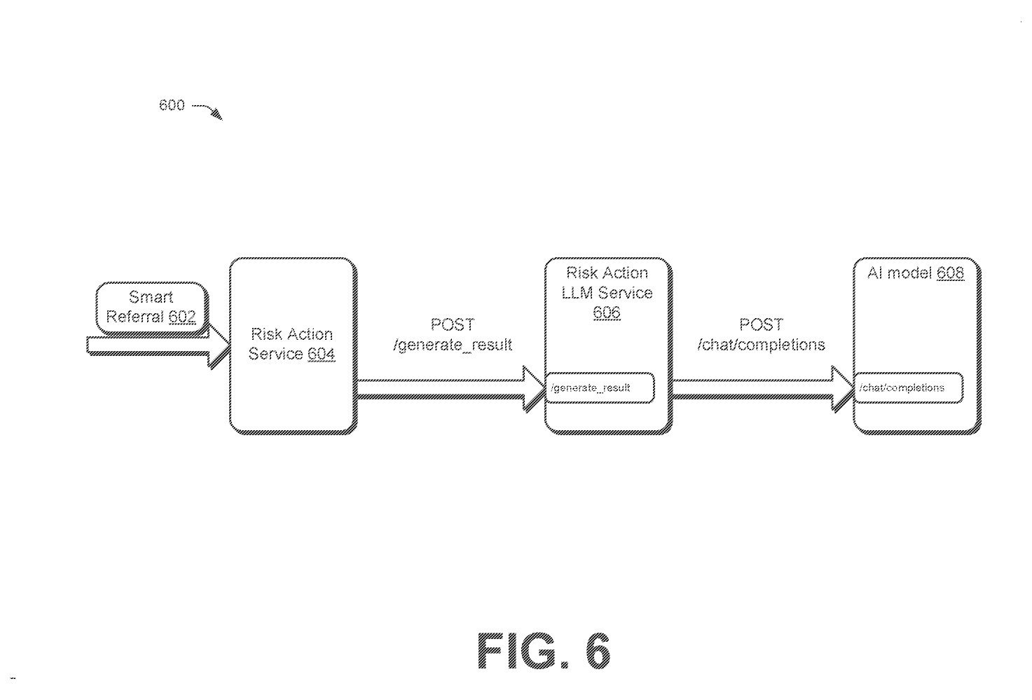

Based on a result of the vector space similarity search 222, the risk action service 204 may generate a prompt for an LLM to generate an AI-based decision regarding a risk level and actioning of the activity. For example, the prompt may be input into the risk action LLM service 212 or the AI model 214. The AI-based decision is described with reference to FIG. 6.

The risk action LLM service 212 or the AI model 214 may output a result that indicates a risk level of the activity. In some examples, the output may indicate a corresponding action. For example, the output may indicate that the activity has a low risk level and is therefore approved, or that the activity has a high-risk level and is therefore rejected. The system may output the AI-based decision via a user interface (e.g., for review by a customer support agent).

FIG. 3 depicts an example 300 of a system for building a historical activity base for an AI-based smart actioning system. The example 300 may be implemented in or otherwise supported by the customer support module 102, the service provider system 104, and the client devices 106 and 108, as described with reference to FIG. 1, and the example 200 as described with reference to FIG. 2.

The example of FIG. 3, a risk action service 304 may operate to identify activities that occur on an online marketplace, such as a user attempting to make a purchase, signing in to their account, listing an item for sale, and the like. The risk action service 304 may receive a new activity (e.g., website activity) via a smart referral 302. The activity may have a set of attributes, such as a user identifier, a date and time, and any other attributes that define the nature of the activity.

The risk action service 304 may send the activity to a customer support service 306 based on the activity being the first of its kind to be referred to the risk action service 304. That is, a database 316 may not already store any activities similar to the new activity. The customer support service 306 may be an electronic platform used by human customer support agents to perform manual review 308 and actioning for the online marketplace. A customer support agent may perform the manual review 308 of the activity by reviewing the attributes. In a case adjudication 310, the customer support agent may provide a final determination or outcome, based on the attributes, as to a risk level of the activity and a corresponding final action. For example, if the activity is a transaction, the customer support agent may determine that the risk level is low and subsequently approve the transaction or that the risk level is high and subsequently reject the transaction. In some implementations, the customer support agent may indicate a reasoning for the risk level and subsequent action.

After the case adjudication 310, the system may generate and publish an event (e.g., a case closure event) that indicates a request associated with the activity, the attributes of the activity, and the outcome of the case adjudication 310. The event may be published at a risk action customer support consumer 312, which may generate a vector (e.g., a vector embedding) that represents the activity. The risk action customer support consumer 312 may transmit a request 314 to the database 316, where the request 314 may include the vector embedding (e.g., the vector representation of the activity) and the outcome. The database 316 may store the request 314 such that the risk action service 304 may utilize the request 314 for a future vector space similarity search.

This process may be repeated for each new activity that is referred to the risk action service 304. Over time, this may result in a vector space of a set of vectors associated with a set of historical activities that occurred on the online marketplace. This vector space may be used to perform vector space similarity searches, as described with reference to FIG. 5.

FIG. 4 depicts an example 400 of a system for generating a query embedding for an AI-based smart actioning system. The example 400 may be implemented in or otherwise supported by the customer support module 102, the service provider system 104, and the client devices 106 and 108, as described with reference to FIG. 1, and the example 200 as described with reference to FIG. 2.

As described herein with reference to FIGS. 2 and 3, the AI-based smart actioning system may use a set of historical manual actioning results (e.g., stored at a database) to identify and automate actioning on similar, new activities based on vector embeddings, vector space similarity searches, and other machine learning techniques. In order to compare a new activity to activities stored in the database to determine if there is any similarity between them, the new activity is converted into a vector.

In the example of FIG. 4, a risk action service 404 may receive a new activity (e.g., website activity) associated with an online marketplace via a smart referral 402. For example, the activity may be any that may occur on the online marketplace, such as a user attempting to make a purchase, signing in to their account, or listing an item for sale. The activity may have a set of attributes (e.g., action attributes), such as a user identifier, a date and time, and any other attributes that define the nature of the activity. The attributes may include any data used by customer support agents and the risk action service 404 to perform actioning on the activity (e.g., accept or reject a transaction).

In one or more implementations, the risk action service 404 may send the activity to a risk action LLM service 406 or an AI model 408 to generate a vector embedding based on the attributes of the activity. The risk action LLM service 406 or the AI model 408 may convert the attributes of the activity to an embedded vector. For example, depending on a desired vector complexity, the risk action LLM service 406 may generate the vector embedding or the AI model 408 may generate the vector embedding. The generated vector may be compared to the set of vectors (corresponding to historical activities) stored at the database using a vector space similarity search (e.g., a k-NN search). In this way, the risk action service 404 may identify whether the activity is similar to any previous activities and if so, perform similar actioning.

In some examples, the risk action LLM service 406, the AI model 408, some other embedding generation model (e.g., a machine learning model) may be used for the vector embedding based on the complexity of the attributes. For example, if the risk action service 404 identifies frequently identifies similar vectors but with low confidence, then the AI model 408 may be used to generate a larger vector (using a more complex embedding algorithm), which may result in a more accurate similarity search. In this way, the risk action LLM service 406, the AI model 408, or any other machine learning model used for vector generation and embedding may be interchangeable.

FIG. 5 depicts an example 500 of a system for preforming a similarity search for an AI-based smart actioning system. The example 500 may be implemented in or otherwise supported by the customer support module 102, the service provider system 104, and the client devices 106 and 108, as described with reference to FIG. 1, and the example 200 as described with reference to FIG. 2.

As described herein, the AI-based smart actioning system may use a set of historical manual actioning results stored at a database 508 to identify and automate actioning on similar, new activities based on vector embeddings, vector space similarity searches, and other machine learning techniques. After generating a vector associated with a new activity (as described with reference to FIG. 4), a risk action service 504 may compare the vector to a set of vectors associated with historical activities and stored in the database 508 to determine if there is any similarity between them.

In the example of FIG. 5, the risk action service 504 may receive a new activity (e.g., website activity) associated with an online marketplace via a smart referral 502. For example, the activity may be any that may occur on the online marketplace (e.g., a user attempting to make a purchase, signing in to their account, or listing an item for sale) and may have a set of attributes (e.g., a user identifier, a date and time, and any other attributes that define the nature of the activity). After generating a vector associated with the new activity, a machine learning model may be executed to perform a vector space similarity search between the generated vector and a set of vectors associated with a set of historical activities associated with the online marketplace. Risk identification and actioning of the historical activities may have been manually performed by a customer support agent or based on a set of deterministic rules. The machine learning model may be trained using a dataset including a vector space of the set of vectors.

In one or more implementations, the vector space similarity search may be a k-NN search 506. The k-NN search may employ a hierarchical navigable small world (HNSW) algorithm to improve efficiency of the search, particularly when the set of vectors is relatively large. To perform the k-NN search 506, the risk action service 504 may input the embedding vector generate for the new activity (e.g., corresponding to a current request), a k-value, and a minimum confidence score. The k-value may represent a quantity of nearest neighbors the search is to output. For example, if k = 5, the k-NN search 506 may output (e.g., return) five vectors from the set of vectors that are most similar to the generated vector corresponding to the new activity. The minimum confidence score may represent how similar the k vectors must be to the generated vector to actually be output (and considered similar). For example, if the minimum confidence score is 0.95, then the k vectors are output only if they are at least 95% similar to the generated vector. As such, if k = 5 and the minimum confidence score is 0.95, but only two of the k = 5 vectors satisfy the minimum confidence score, then the k-NN search 506 may output those two vectors.

At this point, the system may determine that those two vectors are sufficient for performing a risk assessment and actioning on the new activity, Alternatively, if the two vectors output from the k-NN search 506 fail to satisfy or do not meet a threshold quantity of vectors to accurately determine similarity, the risk action service 504 may send the new activity with its attributes to a customer support service (e.g., the customer support service 206 as described with reference to FIG. 2) and a customer support agent may manually perform an evaluation, including risk assessment and actioning, on the activity before its corresponding vector is generated and added to the database 508 to improve the robustness of future similarity searches. If none of the k = 5 vectors satisfy the minimum confidence score, then the k-NN search 506 may not output any vectors, and the risk action service 504 may send the new activity for manual review by a customer support agent.

Values for k and the minimum confidence score may be changed based on the success of the k-NN search 506. For example, as more vectors are added to the database 508, the values for k and the minimum confidence score may be increased.

The k-NN search 506 may output a result of the request (e.g., the input embedding vector, k, and minimum confidence score). The result may be to decline the request (if zero or too few vectors are output) or to approve the request (if a sufficient quantity of similar vectors is output). The k-NN search 506 may also output the similar vectors that satisfy the minimum confidence score. The risk action service 504 may use the output of the k-NN search 506 to determine an outcome (e.g., risk assessment) and perform actioning on the new activity, which is described with reference to FIG. 6.

FIG. 6 depicts an example 600 of a system for generating an AI decision for an AI-based smart actioning system. The example 600 may be implemented in or otherwise supported by the customer support module 102, the service provider system 104, and the client devices 106 and 108, as described with reference to FIG. 1, and the example 200 as described with reference to FIG. 2.

As described herein, the AI-based smart actioning system may use a set of historical manual actioning results stored at a database 508 to identify and automate actioning on similar, new activities based on vector embeddings, vector space similarity searches, and other machine learning techniques. After generating a vector associated with a new activity and comparing that vector to a set of vectors associated with historical activities in a vector space similarity search (as described with reference to FIGS. 4 and 5), a risk action service 604 may use a machine learning model to generate a decision or outcome (e.g., a risk assessment) and actioning for the new activity.

In the example of FIG. 6, the risk action service 604 may receive a new activity (e.g., website activity) associated with an online marketplace via a smart referral 602. For example, the activity may be any that may occur on the online marketplace (e.g., a user attempting to make a purchase, signing in to their account, or listing an item for sale) and may have a set of attributes (e.g., a user identifier, a date and time, and any other attributes that define the nature of the activity). After executing a vector space similarity search (e.g., a k-NN search) between the generated vector and the set of vectors associated with historical activities associated with the online marketplace, the risk action service 604 may generate a prompt for the risk action LLM service 606 (e.g., POST /generate_result) or the AI model 608 (e.g., POST /chat/completions) (or any other machine learning model capable of performing the described techniques) based on the output of the vector space similarity search. The output may include one or more vectors of the set of vectors identified from the vector space similarity search (e.g., the one or more vectors satisfying values for k and a minimum confidence score for a k-NN search). That is, the prompt may include a request associated with the new activity (e.g., the new activity and corresponding attributes indicated in the smart referral 602), the output of the vector space similarity search (e.g., the one or more similar vectors), and an input request (e.g., indicating that the risk action LLM service 606 or the AI model 608 is to determine and outcome and action).

The risk action LLM service 606 or the AI model 608 may use the prompt to generate a response as to whether to approve or decline (e.g., deny) the activity. For example, if the similar activities associated with the one or more vectors output from the vector space similarity search were declined for being high risk (e.g., associated with a fraudulent transaction), then then the new activity may also be declined. In such cases, the new activity may have attributes similar to those of the similar activities (that made them high risk). The risk action LLM service 606 or the AI model 608 may output the outcome and actioning via an application program interface (API).

In one or more implementations, the new activity may be added to the database (in which the set of vectors used for the vector space similarity search are stored) for use in future actioning. For example, the new activity may be similar to a historical activity stored in the database. However, an outcome for the new activity may be determined by the risk action LLM service 606 or the AI model 608 where an outcome for the historical activity may have been determined manually by a customer support agent. In such cases, the new activity may not be added to the database if the new activity is believed that the historical activity is more accurate, having been manually reviewed. Alternatively, the new activity may be added to the database as well, however the new activity may include a label to indicate that the new activity was added based on a determination by the risk action LLM service 606 or the AI model 608, and the historical activity may include a label that the historical activity was added based on manual review by a customer support agent. Alternatively, if the database already includes many activities similar to the new activity, whether evaluated by a machine learning model or a customer support agent, it may be unnecessary to also add the new activity to the database.

In one or more implementations, the system may compare an output from the risk action LLM service 606 or the AI model 608 with a manual output from a customer support agent for the same activity to validate the AI-generated output. In such cases, the risk action service 604 may send the request associated with the new activity and the output of the vector space similarity search to both the risk action LLM service 606 or the AI model 608 and customer support service. The system may compare the outputs to determine the applied machine learning model’s precision, recall, and false positive rates. For example, if the AI-generated output conflicts with the customer support agent’s output, the machine learning model may have output a false positive result (e.g., mistakenly approved a transaction that should have been rejected). Validating the results from the risk action LLM service 606 or the AI model 608 in this way may support reinforcement learning that enriches the database and improves the accuracy of future outputs.

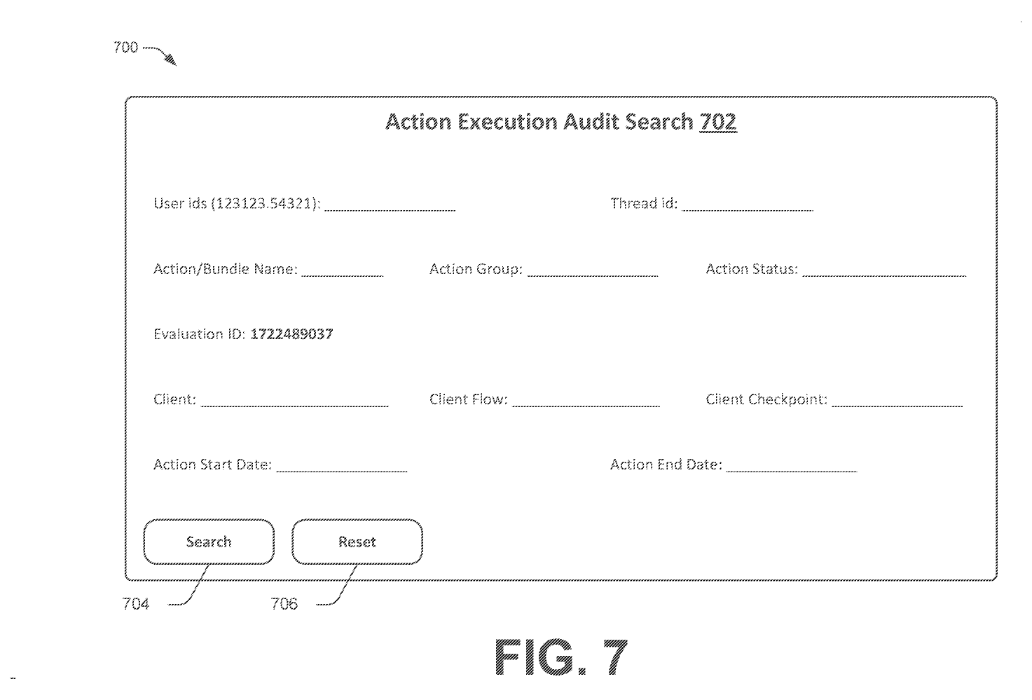

FIG. 7 depicts an example 700 of a user interface for an AI-based smart actioning system.

The example 700 include a user interface for an action execution audit search 702. A customer support agent may use the action execution audit search 702 user interface to search for an action associated with an activity (e.g., whether an activity was approved or declined based on its risk level). In one or more implementations, the action execution audit search 702 user interface may include numerous fields the customer support agent may use to search for a particular activity and action. For example, the fields may include user identifiers (IDs) (e.g., 123123.54321), thread ID, action/bundle name, action group, action status, evaluation ID (e.g., 1722489037), client, client flow, client checkpoint, action start date, and action end date. The action execution audit search 702 user interface may include any combination of the aforementioned fields, and/or may include additional fields used for searching an activity and action.

In the example 700, a customer support agent may search using the evaluation ID field by inputting an ID: 1722489037. The customer support agent may select a search button 704, and the action execution audit search 702 user interface may display a result corresponding to that evaluation ID. For example, the result may indicate attributes associated with an activity and the output of an LLM or other AI model indicating that the activity was approved or rejected. In some implementations, the search may output information about an action such as a date, name, type, mode, or status. The customer support agent may select the reset button 706 to reset the fields and perform subsequent searches using the action execution audit search 702 user interface.

Having discussed exemplary details of an AI-based smart actioning system, consider now some examples of procedures to illustrate additional aspects of the techniques.

### Example Procedures

This section describes examples of procedures for an AI-based smart actioning system. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

FIG. 8 depicts a procedure 800 in an example implementation of an AI-based smart actioning system.

An activity associated with a website and having one or more attributes is received (block 802). By way of example , the website may be associated with an online marketplace 114, and the activity may include an online marketplace activity (e.g., a transaction). By way of example, the customer support module 102 (specifically the risk action service 116 or the customer support service 118) may receive activities 126 from a client device 106 or a client device 108 via an application 112. The activities 126 may be associated with one or more attributes that define the nature of the activities 126, such as a location, date, and user associated with the activities 126.

A vector associated with the activity is generated based on the one or more attributes (block 804). By way of example, the risk action service 116 may generate a vector for each of the activities 126 based om the corresponding attributes. In some implementations, the LLM service 120 or the AI model 122 may be used to generate the vector and embed the vector.

A machine learning model that is trained using a dataset including a vector space comprising a set of vectors representing a set of historical activities associated with the website is executed, which includes a vector space similarity search between the vector and the set of vectors (block 806). By way of example, the risk action service 116 may input the vector generated at block 804 into a vector space similarity search such as a k-NN search, where the generated vector may be compared to the set of vectors in the dataset, which are stored at the database 130. The vector space similarity search may output one or more vectors from the set of vectors that are most similar to the generated vector (based on some similarity metric and confidence level).

A prompt for an LLM is generated based on one or more vectors of the set of vectors identified from the vector space similarity search (block 808). By way of example, the risk action service 116 may generate a prompt for the LLM service 120 or the AI model 122 based on an activity 126 and the one or more vectors output from the vector space similarity search. The prompt may be input to the LLM service 120 or the AI model 122 to determine a risk level and action for the activity 126.

A result received from the LLM that indicates a risk level of the activity is output (block 810). By way of example, the LLM service 120 or the AI model 122 may output the risk level of the activity. The result may also include an action (e.g., approve or decline a transaction) based on the risk level. In some implementations, the result may be output for display at a user interface.

Having described examples of procedures in accordance with one or more implementations, consider now an example of a system and device that can be utilized to implement the various techniques described herein.

### Example System and Device

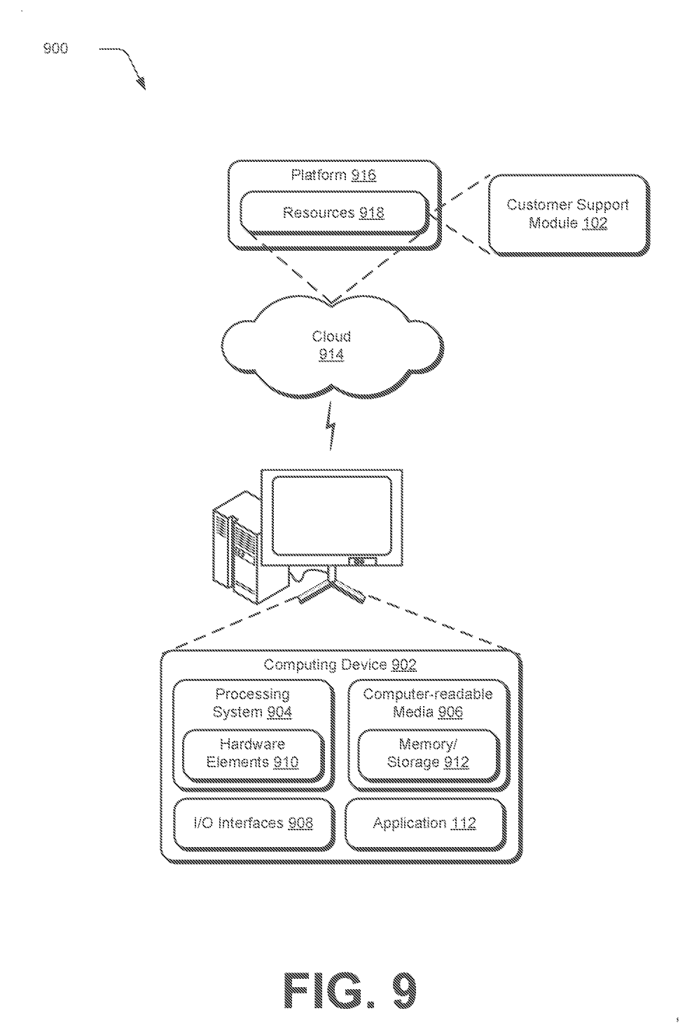

FIG. 9 illustrates an example of a system 900 generally that includes an example of a computing device 902 that is representative of one or more computing systems and/or devices that may implement the various techniques described herein. This is illustrated through inclusion of the application 112 and the customer support module 102. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware elements 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 906 is illustrated as including memory/storage 912. The memory/storage 912 represents memory/storage capacity associated with one or more computer-readable media. The memory/storage 912 may include volatile media (such as random access memory (RAM)) and/or nonvolatile media (such as read only memory (ROM), Flash memory, optical disks, magnetic disks, and so forth). The memory/storage 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving an activity associated with a website, the activity having one or more attributes;
generating a vector associated with the activity based on the one or more attributes;
executing a machine learning model that is trained using a dataset including a vector space comprising a set of vectors representing a set of historical activities associated with the website, the executing including executing a vector space similarity search between the vector and the set of vectors;
generating a prompt for a large language model (LLM) based on one or more vectors of the set of vectors identified from the vector space similarity search; and
outputting a result received from the LLM that indicates a risk level of the activity.

2. The computer-implemented method of claim 1, further comprising:
providing, by one or more processors, the prompt as input to the LLM to determine the risk level of the activity; and
outputting the result received from the LLM for display via a user interface.

3. The computer-implemented method of claim 1, wherein the prompt includes a request associated with the activity, the one or more vectors identified from the vector space similarity search, and an input request to output the risk level.

4. The computer-implemented method of claim 1, further comprising adding the vector associated with the activity to the vector space based at least in part on the result.

5. The computer-implemented method of claim 1, wherein the set of vectors included in the dataset are associated with risk levels based on at least one of: a set of deterministic rules, manual review by a user, or an output from the LLM.

6. The computer-implemented method of claim 1, further comprising sending the activity and the one or more attributes for evaluation by a user based at least in part on a quantity of the one or more vectors identified from the vector space similarity search failing to satisfy a threshold.

7. The computer-implemented method of claim 1, further comprising validating the result received from the LLM based at least in part on an evaluation of the vector associated with the activity performed by a user.

8. The computer-implemented method of claim 1, wherein the vector space similarity search comprises a k-nearest-neighbor (k-NN) search, and wherein the k-NN search is based on a minimum confidence score.

9. The computer-implemented method of claim 1, wherein the result received from the LLM indicates an action associated with the activity based at least in part on the risk level.

10. A system comprising:
a machine learning model that is trained using a dataset including a vector space, the vector space comprising a set of vectors representing a set of historical activities associated with a website;
a large language model (LLM); and
a risk action service configured to:
receive an activity associated with the website, the activity having one or more attributes;
generate a vector associated with the activity based on the one or more attributes;
execute the machine learning model, the executing including executing a vector space similarity search between the vector and the set of vectors;
generate a prompt for the LLM based on one or more vectors of the set of vectors identified from the vector space similarity search; and
output a result received from the LLM that indicates a risk level of the activity.

11. The system of claim 10, wherein the risk action service is configured to:
provide the prompt as input to the LLM to determine the risk level of the activity; and
output the result received from the LLM for display via a user interface.

12. The system of claim 10, wherein the prompt includes a request associated with the activity, the one or more vectors identified from the vector space similarity search, and an input request to output the risk level.

13. The system of claim 10, wherein the risk action service is configured to:
add the vector associated with the activity to the vector space based at least in part on the result.

14. The system of claim 10, wherein the set of vectors included in the dataset are associated with risk levels based on at least one of: a set of deterministic rules, manual review by a user, or an output from the LLM.

15. The system of claim 10, wherein the risk action service is configured to:
send the activity and the one or more attributes for evaluation by a user based at least in part on a quantity of the one or more vectors identified from the vector space similarity search failing to satisfy a threshold.

16. The system of claim 10, wherein the risk action service is configured to:
validate the result received from the LLM based at least in part on an evaluation of the vector associated with the activity performed by a user.

17. One or more computer-readable storage media comprising instructions stored thereon that, responsive to execution by one or more processors, perform operations comprising:
receiving an activity associated with a website, the activity having one or more attributes;
generating a vector associated with the activity based on the one or more attributes;
executing a machine learning model that is trained using a dataset including a vector space comprising a set of vectors representing a set of historical activities associated with the website, the executing including executing a vector space similarity search between the vector and the set of vectors;
generating a prompt for a large language model (LLM) based on one or more vectors of the set of vectors identified from the vector space similarity search; and
outputting a result received from the LLM that indicates a risk level of the activity.

18. The one or more computer-readable storage media of claim 17, wherein the operations further comprise:
providing, by the one or more processors, the prompt as input to the LLM to determine the risk level of the activity; and
outputting the result received from the LLM for display via a user interface.

19. The one or more computer-readable storage media of claim 17, wherein the prompt includes a request associated with the activity, the one or more vectors identified from the vector space similarity search, and an input request to output the risk level.

20. The one or more computer-readable storage media of claim 17, wherein the operations further comprise:
adding the vector associated with the activity to the vector space based at least in part on the result.
